(19) United States
(12) Patent Application Publication
(10) Pub. No.: US 2025/0015722 A1
(43) Pub. Date: Jan. 9, 2025

(54) POWER CONVERSION SYSTEM

(71) Applicant: NANJING EFFICIENT POWER FOR INTELLIGENT COMPUTING TECHNOLOGIES CO. LTD., Nanjing (CN)

(72) Inventors: Xufu REN, Nanjing (CN); Teng Long, Nanjing (CN); Pengcheng Xu, Nanjing (CN)

(73) Assignee: NANJING EFFICIENT POWER FOR INTELLIGENT COMPUTING TECHNOLOGIES CO. LTD., Nanjing (CN)

(21) Appl. No.: 18/745,453

(22) Filed: Jun. 17, 2024

(30) Foreign Application Priority Data
Jun. 16, 2023 (CN) 202310727457.1

(51) Int. Cl. H02M 3/335; H02M 1/00; H02M 3/00

(52) U.S. Cl. CPC H02M 3/3353; H02M 3/01; H02M 1/0058

(57) ABSTRACT

A power conversion system, including resonant capacitor, transformer, and proximal and distal power conversion units connected in parallel between positive and negative input interfaces. Proximal power conversion unit includes power switches S1-S3 connected, and the distal power conversion unit includes power switches Q1-Q3 connected. The transformer includes a primary and two secondary windings with a same number of turns. The resonant capacitor and primary winding are connected, one end is connected between S1 and S2 of the proximal unit, and the other is connected between Q1 and Q2 of the distal unit. The two secondary windings are connected, one end is connected between S2 and S3 of the proximal unit, and the other end is connected between Q2 and Q3 of the distal unit. A positive output port connection line between the two secondary windings, and a negative output port connected to a negative input port through a wire.

### TECHNICAL FIELD

The present invention relates to a power conversion system.

### BACKGROUND

An existing step-down high-current direct current-output power conversion system application generally uses a hybrid switched capacitor conversion circuit, as shown in FIG. 1 and FIG. 2. The hybrid switched capacitor converter circuit has the advantages such as low switching loss and low current stress of a switch tube. Therefore, the converter can operate at a higher switching frequency (several hundred kilohertz to several megahertz), thereby significantly reducing a volume of a magnetic element of the converter and greatly increasing a power density of the converter.

However, the two existing circuits in FIG. 1 and FIG. 2 have a problem that a flexible voltage transformation ratio cannot be realized. For a circuit in FIG. 1, the circuit can only fix an input voltage-output voltage transformation ratio of 4:1. For a circuit in FIG. 2, the minimum input voltage-output voltage transformation ratio is 6:1. Although a larger voltage transformation ratio such as 7:1 and 8:1 may be achieved by changing a turns ratio of transformer windings, in fact, an input voltage-output voltage transformation ratio of 3:1, 4:1, 5:1, or the like is more valuable to bus converters with fixed voltage transformation ratios in data centers and on-board applications.

Therefore, how to develop a power conversion system that may improve the above existing technology is currently an urgent need.

### SUMMARY

A technical problem to be resolved by the present invention is to provide a power conversion system. The power conversion system may flexibly realize a direct current voltage transformation ratio of X:1, where X may be any integer greater than 2, and the power conversion system has technical advantages such as low switching loss and low conduction loss, and is applicable to bus converters in data centers and on-board applications.

To resolve the above technical problem, the technical solution adopted by the present invention is to provide a power conversion system, including a positive input interface, a negative input interface, a positive output interface, a negative output interface, a resonant capacitor Cᵣ, a transformer, and a proximal power conversion unit and a distal power conversion unit connected in parallel between the positive input interface and the negative input interface. An input capacitor is arranged between the positive input interface and the negative input interface. An output capacitor is arranged between the positive output interface and the negative output interface. The proximal power conversion unit includes a proximal first power switch S1, a proximal second power switch S2, and a proximal third power switch S3 connected in series, and the distal power conversion unit includes a distal first power switch Q1, a distal second power switch Q2, and a distal third power switch Q3 connected in series.

The transformer includes a primary winding T₁ and two secondary windings T₂₁ and T₂₂. The two secondary windings have a same number of turns. After the resonant capacitor Cᵣ and the primary winding T₁ are connected in series, one end is connected between the proximal first power switch S1 and the proximal second power switch S2 of the proximal power conversion unit, and the other end is connected between the distal first power switch Q1 and the distal second power switch Q2 of the distal power conversion unit. A dotted terminal of the primary winding T₁ of the transformer is located between the distal first power switch Q1 and the distal second power switch Q2. An undotted terminal of the secondary winding T₂₁ of the transformer is connected to a dotted terminal of the secondary winding T₂₂ of the transformer, a dotted terminal of the secondary winding T₂₁ of the transformer is connected between the proximal second power switch S2 and the proximal third power switch S3, and an undotted terminal of the secondary winding T₂₂ of the transformer is connected between the distal second power switch Q2 and the distal third power switch Q3.

A positive output port is connected to a connection line between the two secondary windings T₂₁ and T₂₂, a negative output port is connected to a negative input port through a wire, and a ground wire is further connected to the wire between the negative output port and the negative input port.

In a preferable solution, the proximal first power switch S1, the distal second power switch Q2, and the proximal third power switch S3 are controlled by a control signal I to be turned on or off at the same time, the distal first power switch Q1, the proximal second power switch S2, and the distal third power switch Q3 are controlled by a control signal II to be turned on or off at the same time, and phases of the control signal I and the control signal II are offset from each other by 180 degrees.

In a preferable solution, the proximal first power switch S1, the proximal second power switch S2, the distal first power switch Q1, and the distal second power switch Q2 each are a Si MOSFET, a GaN HEMT, or a SiC MOSFET.

In a preferable solution, the proximal third power switch S3 and the distal third power switch Q3 each are a Si MOSFET, a GaN HEMT, a SiC MOSFET, or a diode.

In a preferable solution, the primary winding T₁ and the two secondary windings T₂₁ and T₂₂ are wound around a same magnetic core column.

Beneficial effects of the present invention are as follows.

In the power conversion system, the resonant capacitor Cᵣ and a resonant inductor of the transformer generate resonance by controlling operations of the power switches, thereby realizing soft-switching operation of all of the power switches. Specifically, the power switches S1, S2, Q1, and Q2 may realize zero-voltage turn-on. Therefore, there is no turn-on loss, and turn-off loss is greatly reduced. The power switches S3 and Q3 may realize zero-current turn-on and zero-current turn-off without switching loss.

Since all of the power switches operate in a soft switching mode, a switching frequency of the converter may be increased to a high band (hundreds of kilohertz to several megahertz), so that the volume of magnetic elements may be significantly reduced and a higher power density can be obtained.

This technical solution may flexibly realize a direct current voltage transformation ratio of X:1, where X may be any integer greater than 2, so that the technical solution has obvious advantages in application fields of a 48V bus converter in a data center and an on-board 48V bus converter.

According to this technical solution, the transformer winding coupling mode is simpler, and the design difficulty of a high-frequency transformer is significantly reduced. In addition, the resonant capacitor in this technical solution has no DC voltage bias, and therefore a second type of ceramic capacitor with a higher energy density may be selected as the resonant capacitor, thereby further increasing the power density of the converter.

### BRIEF DESCRIPTION OF THE DRAWINGS

FIG. 1 is an existing hybrid switched capacitor conversion circuit.

FIG. 2 is another existing hybrid switched capacitor conversion circuit.

FIG. 3 is a schematic diagram of a circuit topology of the power conversion system.

FIG. 4 is a schematic diagram of an equivalent circuit of the power conversion system.

FIG. 5 is a schematic diagram of a positive half-cycle equivalent circuit of the power conversion system.

FIG. 6 is a schematic diagram of a negative half-cycle equivalent circuit of the power conversion system.

FIG. 7 is a waveform diagram of the power conversion system.

FIG. 8 is a schematic circuit diagram of Embodiment 2 of the power conversion system.

FIG. 9 is a schematic circuit diagram of a placement position of an external inductor in Embodiment 3 of the power conversion system.

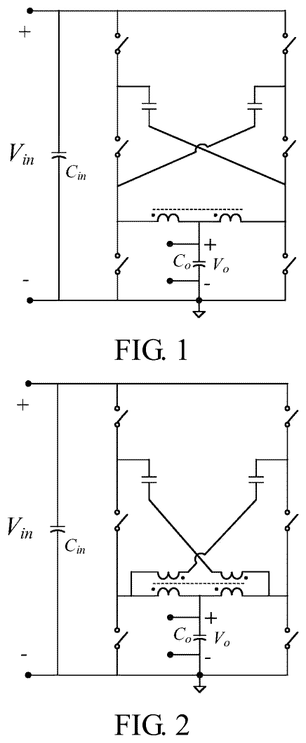

### DETAILED DESCRIPTION

Specific implementations of the present invention are described in detail below with reference to the accompanying drawings.

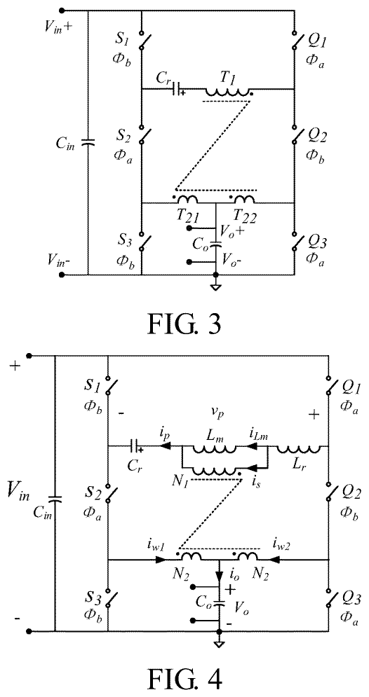

As shown in FIG. 3, a power conversion system is provided, including a positive input interface Vᵢₙ+, a negative input interface Vᵢₙ−, a positive output interface Vₒ+, a negative output interface Vₒ−, a resonant capacitor Cᵣ, a transformer, and a proximal power conversion unit and a distal power conversion unit connected in parallel between the positive input interface Vᵢₙ+ and the negative input interface Vᵢₙ−. An input capacitor Ci₁ is arranged between the positive input interface Vᵢₙ+ and the negative input interface Vᵢₙ−. An output capacitor Co is arranged between the positive output interface Vₒ+ and the negative output interface Vₒ−. The proximal power conversion unit includes a proximal first power switch S1, a proximal second power switch S2, and a proximal third power switch S3 connected in series, and the distal power conversion unit includes a distal first power switch Q1, a distal second power switch Q2, and a distal third power switch Q3 connected in series.

The transformer includes a primary winding T₁ and two secondary windings T₂₁ and T₂₂. The two secondary windings have a same number of turns. After the resonant capacitor Cᵣ and the primary winding T₁ are connected in series, one end is connected between the proximal first power switch S1 and the proximal second power switch S2 of the proximal power conversion unit, and the other end is connected between the distal first power switch Q1 and the distal second power switch Q2 of the distal power conversion unit. A dotted terminal of the primary winding T₁ of the transformer is located between the distal first power switch Q1 and the distal second power switch Q2. An undotted terminal of the secondary winding T₂₁ of the transformer is connected to a dotted terminal of the secondary winding T₂₂ of the transformer, a dotted terminal of the secondary winding T₂₁ of the transformer is connected between the proximal second power switch S2 and the proximal third power switch S3, and an undotted terminal of the secondary winding T₂₂ of the transformer is connected between the distal second power switch Q2 and the distal third power switch Q3.

The proximal first power switch S1, the proximal second power switch S2, the distal first power switch Q1, and the distal second power switch Q2 each are a Si MOSFET. The proximal third power switch S3 and the distal third power switch Q3 each are a Si MOSFET.

A positive output port is connected to a connection line between the two secondary windings T₂₁ and T₂₂, a negative output port is connected to a negative input port through a wire, and a ground wire is further connected to the wire between the negative output port and the negative input port. The primary winding T₁ and the two secondary windings T₂₁ and T₂₂ are wound around a same magnetic core column.

The power switches periodically operate based on a switching cycle, and the resonant capacitor and the resonant inductor generate resonance by controlling turn-on or turn-off of the power switches. The proximal first power switch S1, the distal second power switch Q2, and the proximal third power switch S3 are controlled by a control signal I to be turned on or off at the same time, the distal first power switch Q1, the proximal second power switch S2, and the distal third power switch Q3 are controlled by a control signal II to be turned on or off at the same time, and phases of the control signal I and the control signal II are offset from each other by 180 degrees.

FIG. 4 is an equivalent circuit of FIG. 3, where a transformer including the windings T₁, T₂₁, and T₂₂ is equivalent to an ideal transformer whose turns ratio is N₁:N₂:N₂. After equivalence, a primary magnetizing inductance is marked as Lm, and a primary leakage inductor is marked as Lk.

The operation of the power switch is controlled, so that the resonant capacitor Cᵣ and the resonant inductor Lᵣ generate resonance, and the power switch achieves soft switching operation, where the resonant inductor may be, for example, but not limited to leakage inductor of the transformer or parasitic inductor of cabling. An operating principle of the power conversion system in a t0-t1 stage is specifically as follows:

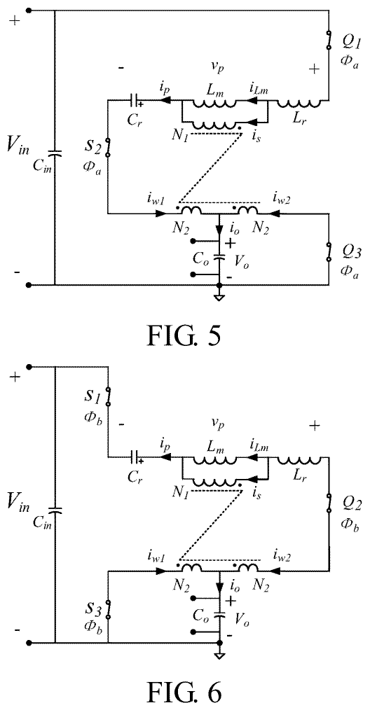

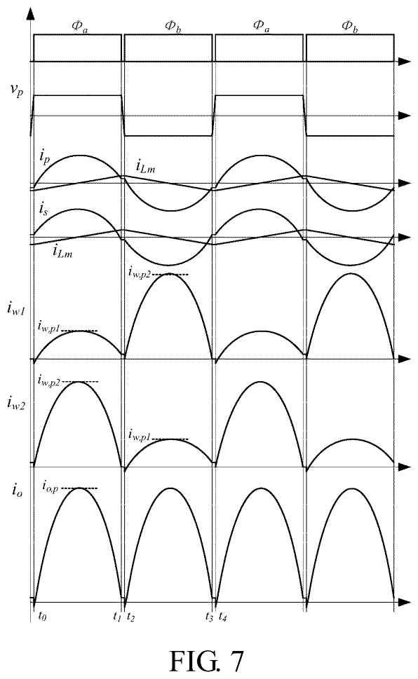

As shown in FIG. 5 and FIG. 7, at a to moment, the distal first power switch Q1, the proximal second power switch S2, and the distal third power switch Q3 are turned on, and a circuit operates in a positive half cycle of resonance, where a resonant frequency fᵣ of the circuit is shown in Equation (1):

$${f}_{r} = \frac{1}{2 π \sqrt{{L}_{r} {C}_{r}}} \qquad ( 1 )$$

In the equation, Cᵣ is the resonant capacitor, and Lᵣ is the resonant inductor.

A switching frequency fₛ of a converter is equal to the resonant frequency fᵣ, that is, fₛ=fᵣ. In a resonant state, a series resistance of the resonant capacitor and the resonant inductor is 0, and according to the Kirchhoff's voltage law, when n is set to N₁/N₂, a voltage transformation ratio is obtained as shown in Equation (2):

$$\frac{{V}_{o}}{{V}_{in}} = \frac{1}{\frac{{N}_{1}}{{N}_{2}} + 2} = \frac{1}{n + 2} \qquad ( 2 )$$

In the equation, Vₒ is an output voltage, Vᵢₙ is an input voltage, N₁ is a number of turns of primary windings of the transformer, and N₂ is a number of turns of secondary windings of the transformer. According to Equation (2), the circuit may achieve an input voltage-output voltage transformer ratio of X:1.

A current of the magnetizing inductance increases linearly, and a change rate of the current is shown in Equation (3):

$$\frac{{di}_{Lm}}{dt} = \frac{{n V}_{o}}{{L}_{m}} \qquad ( 3 )$$

In the equation, i_{Lm} is an exciting current, and Lm is the magnetizing inductance.

A current of the secondary winding T₂₁ of the transformer is equal to a primary resonant current, that is, i_{w1}=iₚ. According to balance of magnetomotive force of the transformer, a current i_{w2} of the secondary winding T₂₂ of the transformer may be obtained as shown in Equation (4):

$${i}_{w 2} = {i}_{p} + {ni}_{s} = {i}_{w 1} + {ni}_{s} \qquad ( 4 )$$

In the equation, iₚ is the primary resonant current, i_{w2} is the current of the secondary winding T₂₂ of the transformer, and iₛ is the secondary resonant current.

At a t₁ moment, the distal first power switch Q1, the proximal second power switch S2, and the distal third power switch Q3 are turned off. Since the current i_{w2} of the secondary winding T₂₂ of the transformer resonates to 0, the distal third power switch Q3 achieves zero-current turn-off. According to Equation (3) and Equation (4), a turn-off current Ip of the distal first power switch Q1 and the proximal second power switch S2 is calculated as:

$${I}_{p} = \frac{{n}^{2} {V}_{o}}{4 ( n + 1 ) {f}_{s} {L}_{m}} \qquad ( 5 )$$

In the equation, fs is the switching frequency.

An operating principle of the power conversion system in a t1-t2 stage is as follows:

After the distal first power switch Q1, the proximal second power switch S2, and the distal third power switch Q3 are turned off at the t1 moment, the circuit operates in a t1-t2 dead zone stage whose duration is defined as td. Generally, a dead time td is much shorter than the switching cycle of operation of the circuit, and the exciting current and the resonant current are approximately considered to be constant in the dead zone stage. A constant current source Ip charges an output capacitor of the distal first power switch Q1 and the proximal second power switch S2, and discharges an output capacitor of the proximal first power switch S1 and the distal second power switch Q2. After charging and discharging are completed, a body diode of the proximal first power switch S1 and the distal second power switch Q2 is turned on and freewheeling is performed, and smooth commutation of a bridge arm voltage vₚ is achieved. After the process is completed, at the t₂ moment, the proximal first power switch S1 and the distal second power switch Q2 achieve zero-voltage turn-on, and the proximal third power switch S₃ achieves zero-current turn-on.

The switching frequency fs, the dead time td, and the magnetizing inductance Lm are properly designed, so that the proximal first power switch S1 and the distal second power switch Q2 achieve zero-voltage turn-on, and the proximal third power switch S₃ achieves zero-current turn-on.

An operating principle of the power conversion system in a t2-t3 stage is symmetrical to that in the t0-t1 stage, which may be obtained through the same analysis. The proximal first power switch S1, the distal second power switch Q2, and the proximal third power switch S₃ are turned on at the t2 moment, the circuit operates in a resonant state, and the resonant frequency is shown in Equation (1). The proximal third power switch S₃ achieves zero-current turn-off at a t3 moment. A turn-off current Ip of the proximal first power switch Si and the distal second power switch Q2 is shown in Equation (5).

An operating principle of the power conversion system in a t3-t4 stage is symmetrical to that in the t1-t2 stage, the following may be obtained through the same analysis. The proximal first power switch S1, the distal second power switch Q2, and the proximal third power switch S₃ are turned off at the t3 moment, and the circuit operates in a t3-t4 dead zone stage. Generally, the dead time td is much shorter than the switching cycle of operation of the circuit, and the exciting current and the resonant current are approximately considered to be constant in the dead zone stage. The constant current source Ip charges the output capacitor of the proximal first power switch S1 and the distal second power switch Q2, and discharges the output capacitor of the proximal second power switch S2 and the distal first power switch Q₁. After charging and discharging are completed, the body diodes of the proximal second power switch S2 and the distal first power switch Q1 are turned on and freewheeling is performed, and the smooth commutation of the bridge arm voltage vₚ is achieved. After the process is completed, at the t₃ moment, the proximal second power switch S2 and the distal first power switch Q1 achieve zero-voltage turn-on, and the distal third power switch Q3 achieves zero-current turn-on. The soft-switching condition of the circuit in the process is shown in Equation (6).

Analysis of voltage stress and current stress of the power switch of the power conversion system is as follows.

Winding currents of the transformer in FIG. 7 are analyzed by using a fundamental wave equivalent model, so as to obtain the following:

$$\{ \begin{matrix}{i}_{w , p 1} = \frac{π {I}_{o , dc}}{2 ( n + 2 )} \\ {i}_{w , p 2} = \frac{π {I}_{o , dc} ( n + 1 )}{2 ( n + 2 )}\end{matrix} \qquad ( 6 )$$

In the equation, i_{w,p1} and i_{w,p2} are peak values of currents of secondary windings of the transformer, as indicated in FIG. 7, and I_{o,dc} is an average value of output currents. Further, the current stress of each power switch may be derived from Equation (7).

The following table is a summary of features of the power switches of the power conversion system:

| Power switch | Voltage stress | Current stress | Soft switching |
|---|---|---|---|
| Proximal first power switch S1 Distal first power switch Q1 | nVₒ | $\frac{π {I}_{o}}{4 ( n + 2 )}$ | Zero-voltage turn-on Turn-off current Ip |
| Proximal second power switch S2 Distal second power switch Q2 | (n + 2)Vₒ | $\frac{π {I}_{o}}{4 ( n + 2 )}$ | Zero-voltage turn-on Turn-off current Ip |
| Proximal third power switch S3 Distal third power switch Q3 | 2Vₒ | $\frac{π {I}_{o} ( n + 1 )}{4 ( n + 2 )}$ | Zero-current turn-on Zero-current turn-off |

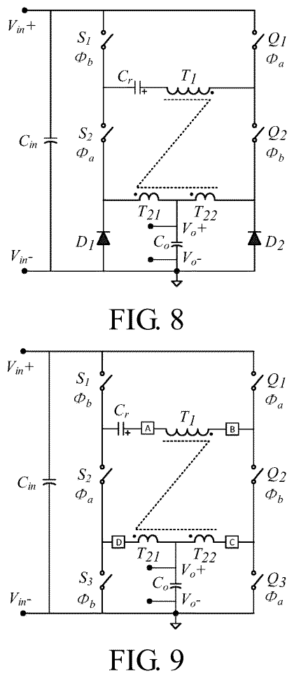

Embodiment 2: As shown in FIG. 8, this embodiment differs from Embodiment 1 in that the proximal third power switch S3 and the distal third power switch Q3 are diodes.

Embodiment 3: As shown in FIG. 9, this embodiment differs from Embodiment 1 in that two ends of the primary winding T₁ are respectively provided with an external inductance connection module A and an external inductance connection module B, and ends of the two secondary windings T₂₁ and T₂₂ away from each other are each provided with an external inductance connection module C.

In the foregoing embodiments, the switching frequency and the resonant frequency of the converter are equal. In some other embodiments, a corresponding power switch may be turned off when the current of the secondary winding of the transformer does not resonate to 0. Due to large capacitance of the resonant capacitor Cᵣ and small inductance of the resonant inductor Lr, although the power device switches are not zero-current turned off, turn-off loss is generally small and may be ignored. Generally, the switching frequency does not exceed twice the resonant frequency.

The foregoing embodiments are merely illustrative descriptions of the principles and effects of the present invention, and a part of embodiments employed, but are not intended to limit the present invention. It should be noted that for a person of ordinary skill in the art, several transformations and improvements can be made without departing from the creative idea of the present invention. All of the transformations and improvements belong to the protection scope of the present invention.

1. A power conversion system, comprising a positive input interface, a negative input interface, a positive output interface, a negative output interface, a resonant capacitor, a transformer, and a proximal power conversion unit and a distal power conversion unit connected in parallel between the positive input interface and the negative input interface, wherein an input capacitor is arranged between the positive input interface and the negative input interface, an output capacitor is arranged between the positive output interface and the negative output interface, the proximal power conversion unit comprises a proximal first power switch, a proximal second power switch and a proximal third power switch connected in series, the distal power conversion unit comprises a distal first power switch a distal second power switch, and a distal third power switch connected in series, the transformer comprises a primary winding and two secondary windings, the two secondary windings have a same number of turns, after the resonant capacitor and the primary winding are connected in series, one end is connected between the proximal first power switch and the proximal second power switch of the proximal power conversion unit, and the other end is connected between the distal first power switch and the distal second power switch of the distal power conversion unit; a dotted terminal of the primary winding of the transformer is located between the distal first power switch and the distal second power switch, an undotted terminal of the secondary winding of the transformer is connected to a dotted terminal of the secondary winding of the transformer, a dotted terminal of the secondary winding of the transformer is connected between the proximal second power switch and the proximal third power switch, and an undotted terminal of the secondary winding of the transformer is connected between the distal second power switch Q2 and the distal third power switch, a positive output port is connected to a connection line between the two secondary windings, a negative output port is connected to a negative input port through a wire, and a ground wire is further connected to the wire between the negative output port and the negative input port.

2. The power conversion system according to claim 1, wherein the proximal first power switch, the distal second power switch, and the proximal third power switch are controlled by a control signal I to be turned on or off at the same time, the distal first power switch, the proximal second power switch, and the distal third power switch are controlled by a control signal II to be turned on or off at the same time, and phases of the control signal I and the control signal II are offset from each other by 180 degrees.

3. The power conversion system according to claim 2, wherein the proximal first power switch, the proximal second power switch, the distal first power switch, and the distal second power switch each are a Si MOSFET, a GaN HEMT, or a SiC MOSFET.

4. The power conversion system according to claim 2, wherein the proximal third power switch and the distal third power switch each are a Si MOSFET, a GaN HEMT, a SiC MOSFET, or a diode.

5. The power conversion system according to claim 1, wherein the primary winding and the two secondary windings are wound around a same magnetic core column.

6. The power conversion system according to claim 2, wherein the primary winding and the two secondary windings are wound around a same magnetic core column.

7. The power conversion system according to claim 3, wherein the primary winding and the two secondary windings are wound around a same magnetic core column.

8. The power conversion system according to claim 4, wherein the primary winding and the two secondary windings are wound around a same magnetic core column.
